(19) United States
(12) Patent Application Publication
(10) Pub. No.: US 2012/0131041 A1
(43) Pub. Date: May 24, 2012

(54) INTERACTIVE STORY COMPILATION

(75) Inventors: Michael E. Ashland, Portland, OR (US); Michael C. Botsko, Beaverton, OR (US)

(73) Assignee: MEOGRAPHY INCORPORATED, Portland, OR (US)

(21) Appl. No.: 12/954,549

(22) Filed: Nov. 24, 2010

(51) Int. Cl. G06F 3/01; G06F 17/30

(52) U.S. Cl. 707/769; 715/751; 707/E17.014

(57) ABSTRACT

Disclosed are methods, apparatus, systems, and non-transitory, tangible computer-readable media associated with facilitating publishing of written material. In various embodiments, an interactive story compiler provides stored questions and stores the written responses created in return. The author may then publish his or her various written responses as a book. The author may invite other people to collaborate or to read the written responses as they are prepared. In various embodiments, other users of the interactive story compiler may create compiled books using written responses from various authors, such as by searching for responses and compiling the results of the search. These compiled books may comprise related responses, such as responses related by keyword or by time period.

### BACKGROUND

Individuals often seek to tell stories of themselves and their experiences. In particular, people may wish to record their stories so that other people can enjoy them at a later date. In a common scenario, a person, or multiple people, will attempt to write down their experiences for later perusal, such as in a book. However, the process of writing a book from scratch can be a daunting one, especially for people with limited writing experience. In cases involving multiple writers, it may also be difficult for the writers to determine a system for collaborating and compiling their efforts into a coherent volume.

Additionally, while stories are often told in a linear or biographical fashion, there also exists a need for compiling stories by multiple authors about similar subjects. However, these authors may be unknown to each other or not realize that their stories are valuable when combined with others' stories. Identification and acquisition of these stories may therefore be difficult.

### BRIEF DESCRIPTION OF THE DRAWINGS

Embodiments of the present invention will be readily understood by the following detailed description in conjunction with the accompanying drawings and flow charts. Embodiments of the invention are illustrated by way of example and not by way of limitation in the figures of the accompanying drawings.

FIG. 1 is a block diagram illustrating components of an interactive story compiler as well as interactions between users and the interactive story compiler;

FIG. 2 is a block diagram illustrating exemplary written responses received and published in accordance with the interactive story compiler;

FIG. 3 is a flowchart illustrating an exemplary process for the interactive story compiler to publish one or more books;

FIG. 4 is a flowchart illustrating an exemplary process for the interactive story compiler to begin creating a book;

FIG. 5 is an exemplary interface provided by the interactive story compiler for displaying available books to a user;

FIGS. 6a and 6b are exemplary interfaces provided by the interactive story compiler for receiving user settings relating to books;

FIG. 7 is an exemplary interface provided by the interactive story compiler for modifying book interactivity settings;

FIG. 8 is a flowchart illustrating an exemplary process for the interactive story compiler to receive a written response to be used in a book;

FIG. 9 is an exemplary interface provided by the interactive story compiler for a user to select a question to direct a response for inclusion in a book;

FIG. 10 is an exemplary interface provided by the interactive story compiler for a user to select a question to direct a response for inclusion in a book;

FIG. 11 is another exemplary interface provided by the interactive story compiler for a user to select a question to direct a response for inclusion in a book;

FIG. 12 is another exemplary interface provided by the interactive story compiler for a user to select already-answered questions to direct a response for inclusion in a book;

FIG. 13 is an exemplary interface provided by the interactive story compiler for entering a written response to a stored question;

FIG. 14 is an exemplary interface provided by the interactive story compiler for entering a new question and a written response to the new question;

FIG. 15 is a flowchart illustrating an exemplary process for the interactive story compiler to facilitate an author in publishing a book;

FIG. 16 is a flowchart illustrating an exemplary process for the interactive story compiler to facilitate publishing a compiled book; and

FIG. 17 is a block diagram illustrating a generalized example of a computing environment on which several of the described embodiments may be implemented.

All figures are ranged in accordance with various embodiments of the present disclosure.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments or implementations of the present invention, are synonymous. The term “exemplary” is used herein merely illustrates that an example is being shown or described and is not intended to denote that any so-described feature is preferred or required over any other. Additionally, while flowcharts and descriptions of processes may make reference to particular steps, it should be understood that, in alternative implementations, the illustrated steps may be combined or divided into two or more sub-steps.

Various embodiments are directed to computer-implemented methods, processes, systems, apparatuses, and non-transitory, tangible computer-readable media for facilitating publishing of written material. In various embodiments, an interactive story compiler facilitates one or more authors in providing written material to be compiled into a book. In various embodiments, the interactive story compiler may provide questions which direct an author to provide written responses. These responses may, in various embodiments, be provided with a goal of publishing the responses together as a single book, or as multiple books.

By using questions to direct written responses, various embodiments of the interactive story compiler may facilitate authors in generating content. This help may be particularly strong where the questions are focused to ask about stories, facts, or events which are personal to the authors. In various embodiments, the authors may respond to pre-determined questions which have been stored by the interactive story compiler. In other embodiments, the authors may provide their own questions and generate written responses to the author-generated questions. In various embodiments, the written responses may be made public, or may be marked private for review only by those persons the author or authors identify.

In various embodiments, the interactive story compiler may also facilitate the publication of one or more topically- or temporally-related stories as one or more books. For example, in various embodiments, the interactive story compiler may allow a user to select one or more written responses stored on the interactive story compiler and combine these responses into a book. In various embodiments, the user may be able to select stories through the use of a search query. By allowing a user to search through and compile responses from multiple authors, the interactive story compiler may facilitate the creation of new, topically-focused books from material that has already been written.

While some embodiments described herein are focused on the recording of “stories,” and in particular biographical stories, in various embodiments other types of information may be recorded using the interactive story compiler and techniques described herein. In some embodiments, fictional information may be recorded. In some embodiments, scenes and timelines may be recorded, such as for stage plays or screenplays. In some embodiments, character development events and timelines may be recorded. In various embodiments, stories may be compiled based on timelines, characters, scenes, etc., in order for an author, playwright, or screenwriter to view related events from multiple perspectives. This may aid in generating consistent content.

In other embodiments, techniques described herein may be utilized for information collection for publishing end of life choices, such as burial wishes, memorial wishes, music, distribution of items, notes for survivors, etc. In some embodiments, techniques described herein may be utilized to provide project-based and/or organizational questions for collecting and capturing group stories. In various examples, information may be recorded for various groups, such as classes, companies, families, non-profit organizations, churches, projects, etc.

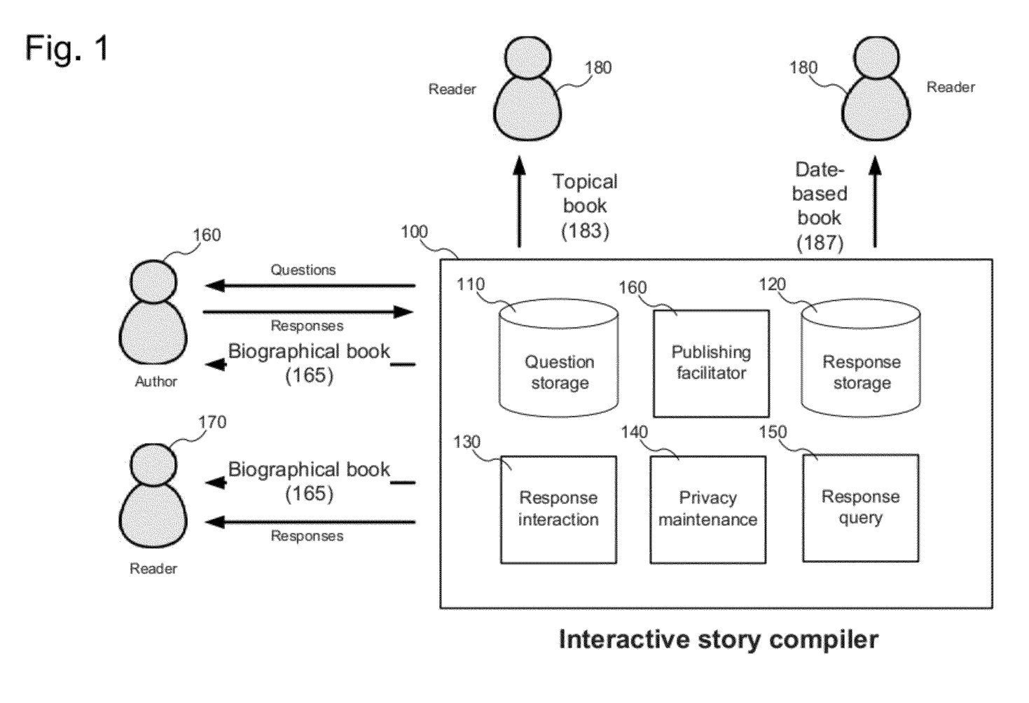

FIG. 1 is a block diagram illustrating components of an interactive story compiler 100, as well as information flows between the interactive story compiler 100 and various authors and readers. While the example of FIG. 1 illustrates particular modules, storage units, and other entities, in various embodiments the interactive story compiler 100 may omit one or more of these elements, may combine illustrated elements and/or may comprise additional elements which are not illustrated. While particular author and readers are illustrated, in various embodiments the interactive story compiler 100 may interact with multiple authors and/or readers.

As illustrated, the interactive story compiler 100 comprises question storage 110 and response storage 120. In various embodiments, the question storage 110 and response storage 120 may comprise various forms of data storage, including hard drives, solid state drives, and removable and/or magnetic media. Additionally, in various embodiments, the data stored on the question storage 110 and response storage 120 may be maintained in various formats, including for example as a database or in one or more separate files.

In various embodiments, the question storage 110 is configured to store one or more pre-determined questions which may be presented to an author, such as author 160, to direct the author to create a written response. In various embodiments, the response interaction module 130 of the interactive story compiler 100 may operate to present questions to an author and to receive written responses in return. In one embodiment, the response interaction module 130 may provide one or more web-based interfaces to authors and/or readers to allow interaction with the interactive story compiler 100. In various embodiments, the response interaction module may retrieve questions from the question storage 110, such as through a direct file retrieval or through a file request. In various embodiments, the response interaction module may store responses received from authors in the response storage 120, such as through direct file storage, or by sending a storage request to the response storage 120. In various embodiments, multiple authors may work together to provide written responses to be included in a book that is common to both authors.

In various embodiments, the response interaction module may provide questions and receive answers through various interfaces, such as through web pages and/or applications. In various embodiments, the response interaction module may provide questions and receive answers through various devices, including desktop and laptop computers, as well as mobile devices, such as through a web page viewed through a mobile browser or on a mobile app. While, in various embodiments discussed herein, responses are referred to as “written” responses, in some embodiments, responses may be input through other means, such as through voice transcription on a desktop computer or mobile device. Particular examples of interaction between the response interaction module 130 and authors are described below.

In various embodiments, the response interaction module 130 may also interact with non-author users, such as reader 170, to provide one or more previously-received responses to the reader in response to a request by the reader 170. In some embodiments, these responses may be responses that have been marked as being publicly available by their authors. In other embodiments, these responses may not be publicly viewable. In such scenarios, an author may indicate to the interactive story compiler 100 that he or she wishes for a particular user to be able to read one or more of the author's written responses. In various embodiments, the privacy maintenance module 140 may interact with authors and/or readers to provide for the setting of these permissions, as well as to control which written responses are allowed to be viewed by various readers.

An author, after submitting written responses, may wish to publish the responses as a book. Thus, in various embodiments, the publishing facilitator 160 may collect information from an author or authors and may combine this information with stored written responses to publish a book. In some embodiments, the publishing facilitator 160 may facilitate publishing of books, such as biographical book 165, and facilitate delivery of those books to the author or authors that contributed to the book. In other embodiments, the publishing facilitator 160 may also facilitate delivery to one or more readers, such as reader 170, as requested by the author 160. In various embodiments, the publishing facilitator 160 may generate one or more files which may be sent to a publishing service for printing and binding in book form.

While embodiments are described herein for the sake of simplicity with reference to generating “a book” or “books,” it may be recognized that embodiments should not be read to be limited only to publication of books. In various embodiments, the publishing facilitator 160 may publish responses in various forms, such as in pamphlets, hardback and/or paperback books, or in other printed forms. Additionally, in various embodiments the publishing facilitator 160 may provide written responses to a publishing service for electronic publishing, such as in e-book format, PDF or XPS format, e-mail, or as a web page. In some embodiments, the publishing facilitator itself may publish the material, such as through interaction with one or more printing devices, or by generating files of publishable quality, such as files in PDF, postscript, or XPS format.

In addition to authors publishing their own written material, in various embodiments, a user may utilize the interactive story compiler 100 to create one or more books with a common theme, as described herein. In various embodiments, the response query module 150 may perform search queries on written responses stored in the response storage 120 in order to identify one or more written responses which are related to a common theme. In one embodiment, the search query may be performed based on one or more keywords, such as words found in written responses. In another, the query may be performed on tags associated with written responses, such as user-generated tags or tags generated by one or more operators of the interactive story compiler 100. In another embodiment, the response query module 150 may search through written responses which are associated with time periods by performing a search based on a search query comprising a time period. In various embodiments, one or more of these types of queries may be combined.

Upon identification of one or more written responses which are identified from a search query, the response query 150 may interact with the publishing facilitator to publish one or more of the found written responses. Thus, in various embodiments, the interactive story compiler 100 may lead to the publication of a book with stories centered around a common theme, such as the topical book 183, or a book with stories centered around a common date or time period, such as date-based book 187. These books may, in turn, be published to one or more readers, such as readers 180.

In various embodiments, use of the interactive story compiler 100 to publish books which are compilations of responses from multiple authors may include the granting of permission from the authors for republishing of their material. In some embodiments, authors may license use of their work for use by a user of the interactive story compiler 100 to create compiled books. In some embodiments, this license may be granted in exchange for the author being granted use of the interactive story compiler 100 to generate his or her own books. In another embodiment, one or more authors may grant a license for their written responses to be republished in exchange for a monetary payment. In some embodiments, the authors may themselves pay a fee for use of the interactive story compiler to compile and publish their work. In some such embodiments, authors may pay a reduced fee in exchange for granting a license to republish their work. In various embodiments, authors may execute a complete transfer of all copyright in their work, rather than a license for particular uses. In some such embodiments, the authors may then be granted a limited license to publish the work they create in their own book. In various embodiments, licensing agreements may contain terms as to a division of revenues or profits between an author and a party controlling the interactive story compiler 100.

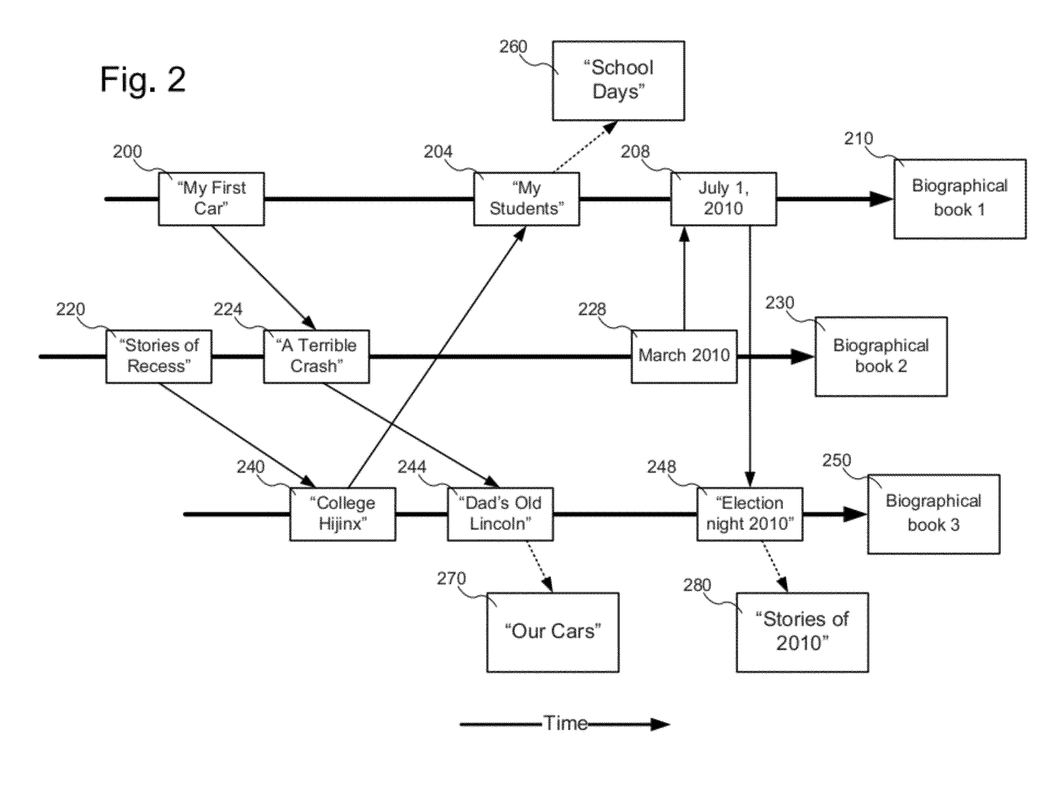

FIG. 2 illustrates example written responses which may be published in more than one book by the interactive story compiler 100. In the example of FIG. 2, three biographical books are illustrated as a timeline, the timeline including three exemplary written responses which are compiled to form part of the books. Thus, in the first timeline, the biographical book 1 (210) comprises, in chronological order, the written responses entitled “My First Car” (200), “My Students” (204) and a response with the date Jul. 1, 2010 (208). Similarly, biographical book 2 (230) comprises written responses “Stories of Recess” (220), “A Terrible Crash” (224), and a story dated March 2010 (228). Biographical book 3 (250) comprises “College Hijinx” (240), “Dad's Old Lincoln” (244), and “Election Night 2010” (248).

However, as FIG. 2 shows, additional books may be created by compiling written responses across the illustrated timelines. Thus, for example, the book “School Days” (260) comprises “Stories of Recess” (220), “College Hijinx” (240), and “My Students” (204). Such a book may be created, in various embodiments, by searching for written responses associated with, for example, school-related keywords or school-related tags. Similarly, the book “Our Cars” (270) comprises the “My First Car” (200), “A Terrible Crash” (224), and “Dad's Old Lincoln” (244) stories.

In another example, a book may be created as a compilation of stories that take place during a particular time period. Thus, in the example book of “Stories of 2010,” the book comprises the stories that took place on March 2010 (228), Jul. 1, 2010 (208), and “Election Night 2010” (248). In the case of “Election Night 2010” the story may be associated, in various embodiments, with the time period 2010 through direct association with a date in the year 2010, and/or because it contains the keyword “2010.” It may be noted that, in the examples given in FIG. 2, the written responses may or may not be compiled in chronological order when compiled into a book. In various embodiments, users and/or authors may be provided with a facility for determining in what order stories may be published.

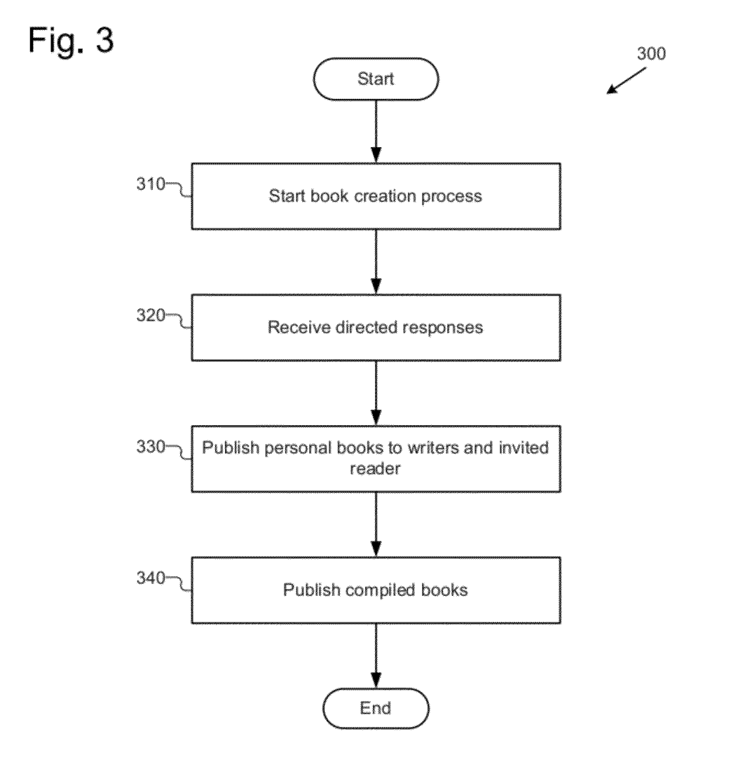

FIG. 3 is a flowchart illustrating an exemplary process 300 for publishing one or more books in accordance with the interactive story compiler 100. In various embodiments, one or more of the operations illustrated in FIG. 3 may be combined, split into multiple operations, or omitted altogether. The process may begin at operation 310, where a user, such as an author, may start the book creation process. In various embodiments, the process of book creation may include the user creating an account on the interactive store compiler 100 and choosing settings for the book, including other authors or readers with whom the book will be shared. Particular embodiments of book creation processes are described below. Next, at operation 320, the interactive story compiler 100 may receive one or more directed written responses, such as responses to pre-determined questions or to author-generated questions. Particular embodiments of receiving directed written responses are described below.

At operation 330, the interactive story compiler 100 may publish personal books, such as those books that were set up and created by authors. The interactive story compiler 100 may publish these books, in various embodiments, to the original author(s) themselves, and/or to readers which have been invited by the author(s). Particular embodiments of publishing processes are described below. At operation 340, the interactive story compiler 100 may also publish compiled books, such as at the direction of a user other than an author of the written responses. Particular embodiments of publication of compiled books are described below.

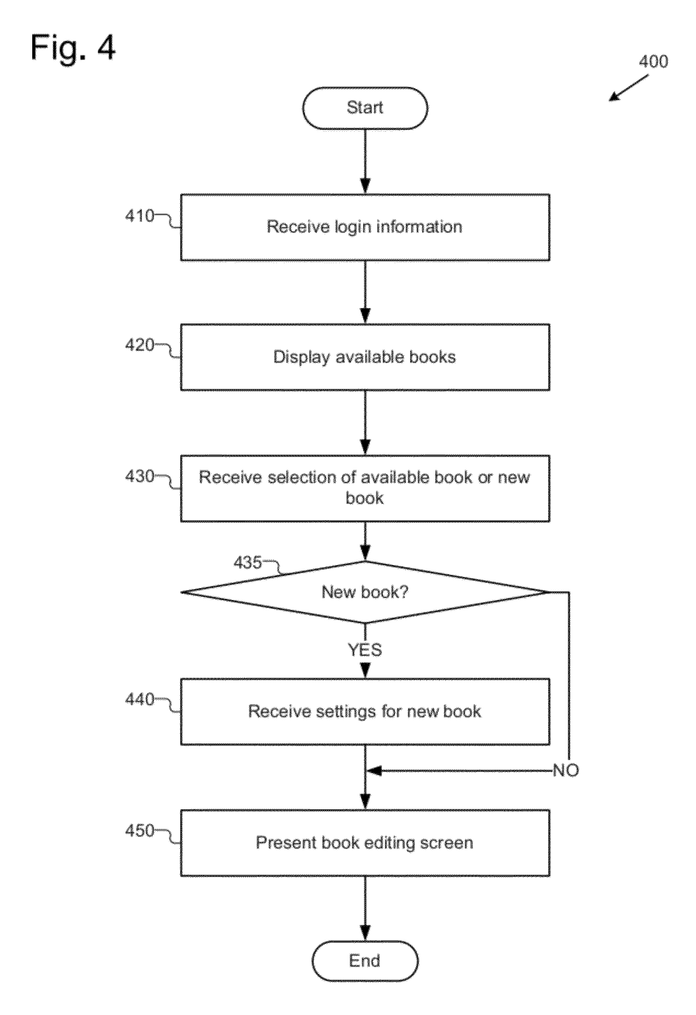

FIG. 4 is a flowchart illustrating an exemplary process 400 for creating a book. In various embodiments, one or more of the operations illustrated in FIG. 4 may be combined, split into multiple operations, or omitted altogether. The process may begin at operation 410, where the interactive story compiler 100 may receive login information, such as for an author. In various embodiments, receiving login information may include creation of an account. In some embodiments, the creation of the account may include one or more of: receiving personal identifying information, receiving payment information, and/or receiving indications that the user assents to one or more legal agreements. For example, in order to access features of the interactive story compiler 100, a user my be required to agree to a licensing deal or to a payment plan. In various embodiments, the user may be required to select a payment plan based on how many features he or she wishes to use from the interactive story compiler 100. For example, a user may be provided an option to create a single book for free, while more than one book costs a per-month fee. In another example, an author may be required to sign up for a particular level of payment in order to invite other collaborating authors to work on a book. In various embodiments, at operation 410, the interactive story compiler 100 may receive login and password information to identify an author or reader's identity.

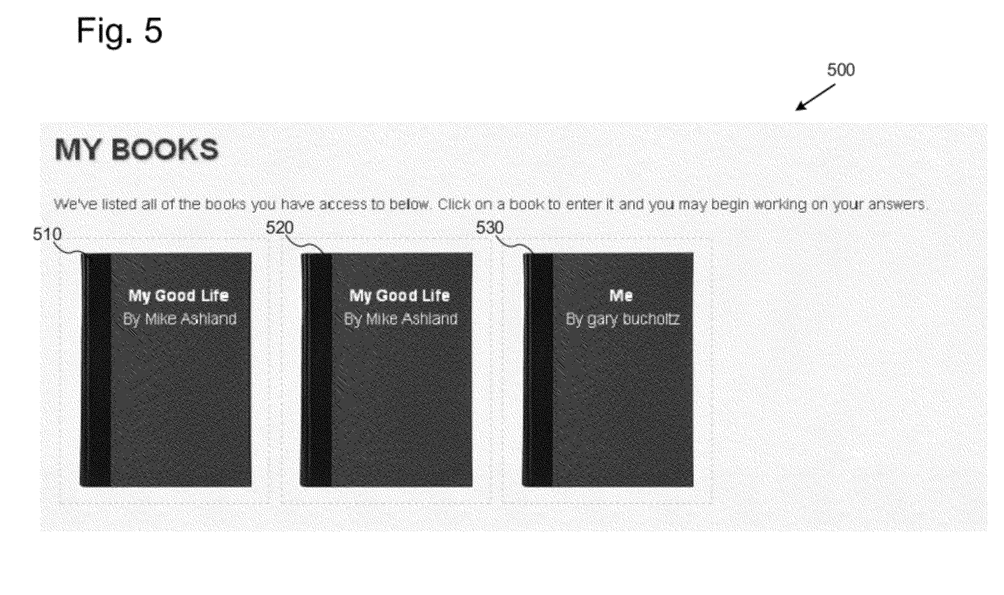

At operation 420, the interactive story compiler 100 may display available books to a user. FIG. 5 illustrates one example of an interface 500 for displaying available books. While the interface example of FIG. 5 illustrates particular graphical elements and offers particular interactions to a user, it will be recognized that, in various embodiments, different interfaces may include different graphical and/or interactive configurations. Interface 500 illustrates three books, 510, 520, and 530, which may be selected for editing and/or publishing by a user. In the illustrated example of FIG. 5, the books are illustrated with reference to their titles (e.g., “My Good Life”) and their authors (e.g., “Mike Ashland”). In various embodiments, books may be identified with other information, such as with unique identifiers, images, colors, etc.

Returning to FIG. 4, at operation 430, the interactive story compiler 100 may receive a selection of a book. In embodiments in accordance with the example interface of FIG. 5, said selection may comprise a mouse click or other interaction with a displayed book. In various embodiments, at operation 430, a user may indicate that he or she wishes to create a new book rather than to work with a book that has already been created. In one embodiment, a book-selection interface may include a “New Book” element for interaction by the user. Thus, at operation 435, the interactive story compiler 100 may determine if the user selected to create a new book.

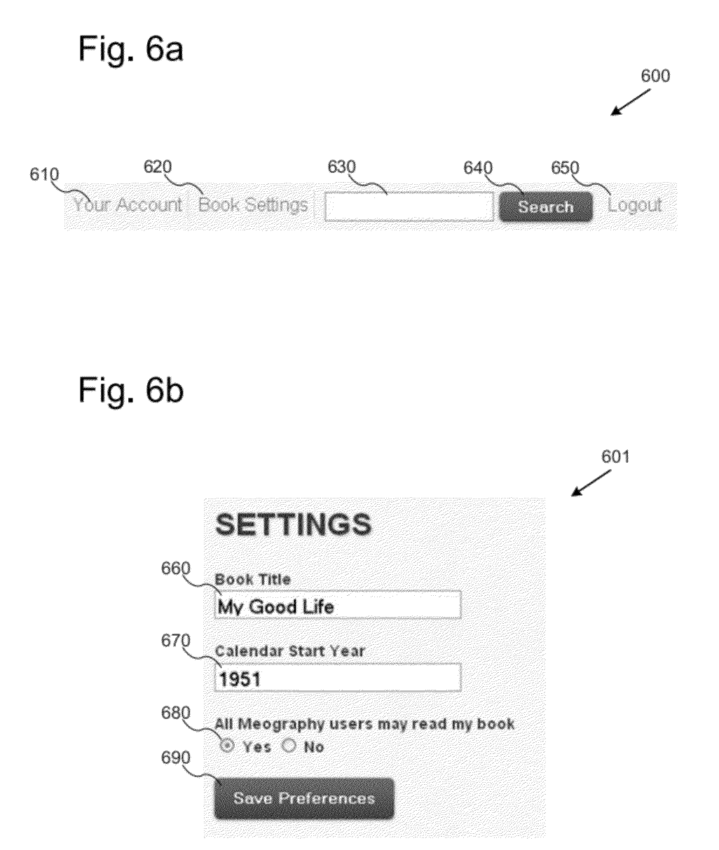

If the user did select to create a new book, then at operation 440, the interactive story compiler 100 may receive one or more settings for the new book. FIGS. 6a and 6b illustrate exemplary interfaces 600 and 601 for receiving user settings for books. While the interface examples of FIGS. 6a and 6b illustrate particular graphical elements and offer particular interactions to a user, it will be recognized that, in various embodiments, different interfaces may include different graphical and/or interactive configurations. As illustrated in FIG. 6a, in various embodiments, the interactive story compiler 100 may include a user account access element 610 through which the user may access and change settings for his or her account. In various embodiments, the interactive story compiler 100 may also include a search query box 630 along with a search execution element 640. In various embodiments, the interactive story compiler 100 may allow a user to enter search query terms in to the search box 630 and to search stored written responses based on the entered search query after receiving activation of the search execution element 640. In various embodiments, the interactive story compiler 100 may also include a logout element 650 for allowing a user to log out of his or her account.

The interactive story compiler 100 may also provide a book settings element 620 which, upon activation, allows a user to access an interface for changing book settings. In various embodiments, the interactive story compiler 100 may provide book setting interface 601 of FIG. 6b to a user after activation of the book settings element 620. In various embodiments, the interactive story compiler 100 may provide a book title entry element 660 for an author to enter or edit the title of the book for which settings are being changed. In various embodiments, the interactive story compiler 100 may provide a calendar start year entry element 670 for a user to enter or edit a starting year for the book. In various embodiments, by changing the start year through element 670, the user may affect which dates are available for selection during book editing, as will be illustrated below.

In various embodiments, the interactive story compiler 100 may also provide a global public privacy setting element 680, whereby an author may set that his or her book is available to all users of the interactive story compiler 100. In some embodiments, if the global public privacy setting element 680 is selected in the negative, the interactive story compiler 100 may prevent access to stored written responses associated with the book by any users other than those authors or readers associated with the book. In some embodiments, if the global public privacy setting element 680 is selected in the negative, the interactive story compiler 100 may allow authors to set privacy permissions on a per-response basis. Finally, the interactive story compiler 100 may also provide a save preferences element 690 which, when activated by an author, causes the edits to the information entered through interface 601 to be saved and applied to the book.

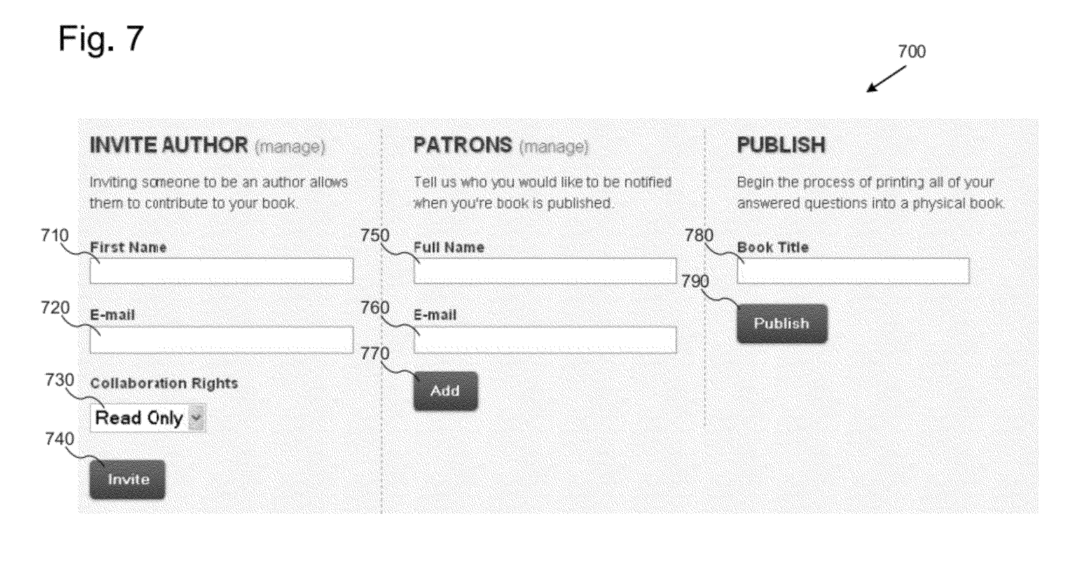

FIG. 7 illustrates one example of an interface 700 for facilitating a user in modifying book interactivity settings. While the interface example of FIG. 7 illustrates particular graphical elements and offers particular interactions to a user, it will be recognized that, in various embodiments, different interfaces may include different graphical and/or interactive configurations. As illustrated in FIG. 7, in various embodiments, the interactive story compiler 100 may provide the ability for one author to invite a new author for the book, for example to collaborate with the new author. In various embodiments, the interactive story compiler 100 may provide an author name entry element 710 and an author email entry element 720 so that an author can identify a new author to invite. In various embodiments, the interactive story compiler 100 may also provide an author collaboration rights selection element 730, through which the author may decide if the person being invited will be another author, or will only be able to access stored written responses on a “read only” basis. The interactive story compiler 100 may also provide an author invite element 740. In various embodiments, activation of the author invite element 740 may cause the interactive story compiler 100 to send an invitation to the identified user. In various embodiments, the identified user may then be allowed to create an account and to interact with the book as allowed by the selection of the author collaboration rights selection element 730.

In various embodiments, the interactive story compiler 100 may provide an author with the ability to invite a patron, who is a person who may be contacted when the book is published. Thus in various embodiments, the interactive story compiler 100 may provide a patron name entry element 750, a patron email entry element 760, and a patron invite element 770. In various embodiments, activation of the patron invite element 770 may cause the interactive story compiler 100 to store the information about the identified patron and to contact the identified patron upon publication of the book.

In various embodiments, and as discussed herein, the interactive story compiler may also provide an author with an option to publish the book. Thus, in various embodiments, the interactive story compiler 100 may provide a book name entry element 780 and a book publish element 790. In various embodiments, activation of the book publish element 790 may cause the interactive story compiler 100 to begin a publication process, as discussed herein.

Returning to FIG. 4, after receiving settings for the new book at operation 440, or directly after receiving a book selection if the user selected an existing book, the interactive story compiler 100 may then, at operation 450, present a book editing screen to the user.

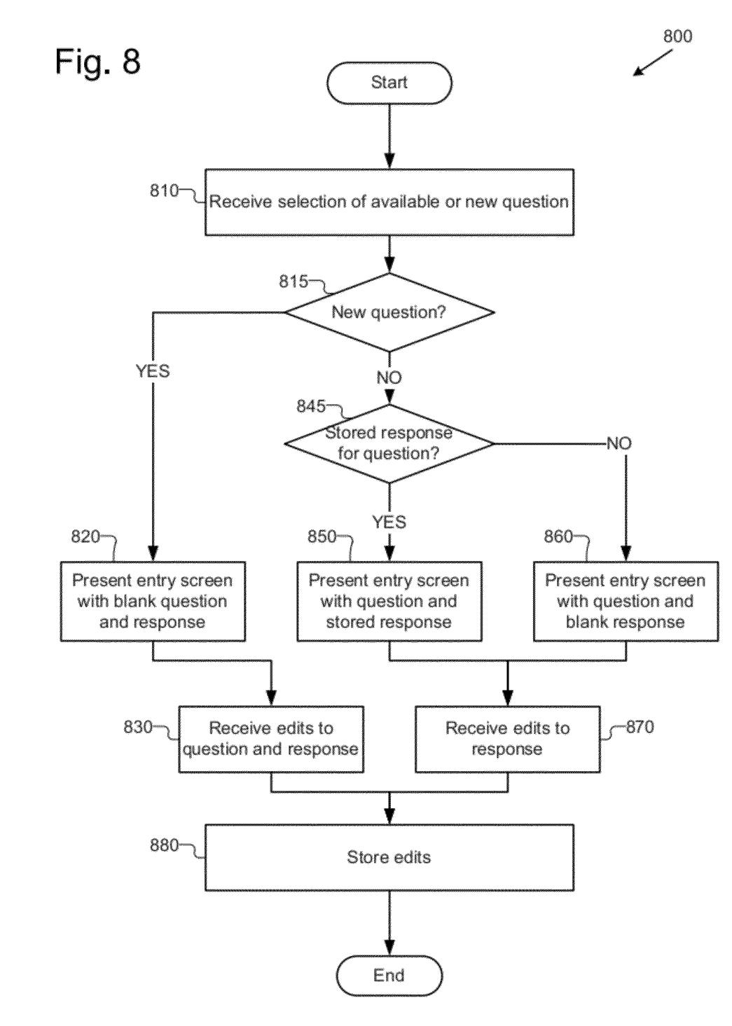

FIG. 8 is a flowchart illustrating an exemplary process 800 for creating a book in accordance with the interactive story compiler 100. In various embodiments, one or more of the operations illustrated in FIG. 8 may be combined, split into multiple operations, or omitted altogether. The process may begin at operation 810, where the interactive story compiler 100 may receive a selection of an available question or a new question. At operation 815, the interactive story compiler 100 may determine if a new question was selected. If so, then at operation 820, the interactive story compiler 100 may present a written response entry screen with blank question and answer entry elements and at operation 830 the interactive story compiler 100 may receive edits to both the question and the answer. In various embodiments, edits may include additions, deletions, and/or modifications to a written response. In various embodiments, edits may also include indication of a time period associated with the written response. Such a time period may be, in various embodiments, a range of time, such as a year or a month, or a specific date. In various embodiments, a time of day may be indicated as well. In various embodiments, edits may also include the addition, deletion, or modification of an image to be associated with the written response.

After receiving the edits, at operation 880 the interactive story compiler 100 may then store the edits. In various embodiments, the interactive story compiler 100 may store the newly-edited question in the question storage 110 and the newly-submitted written response in the response storage 120.

If, however, the interactive story compiler 100 determines that a new question was not selected at operation 815, then at operation 845 the interactive story compiler 100 may determine whether a response is currently stored for the selected question. If a response is already stored, then at operation 850 the interactive story compiler 100 may present the author with a response entry screen that contains the question as well as the text of the currently-stored response. If the interactive story compiler 100 determines that no response is stored, then at operation 860, the interactive story compiler 100 may present the author with a response entry screen that contains the selected question as well as a blank response entry element. In either event, the process continues to operation 870, where the interactive story compiler may receives edits to the response. Then, at operation 880, the interactive story compiler 100 may store the edits. The process may then end.

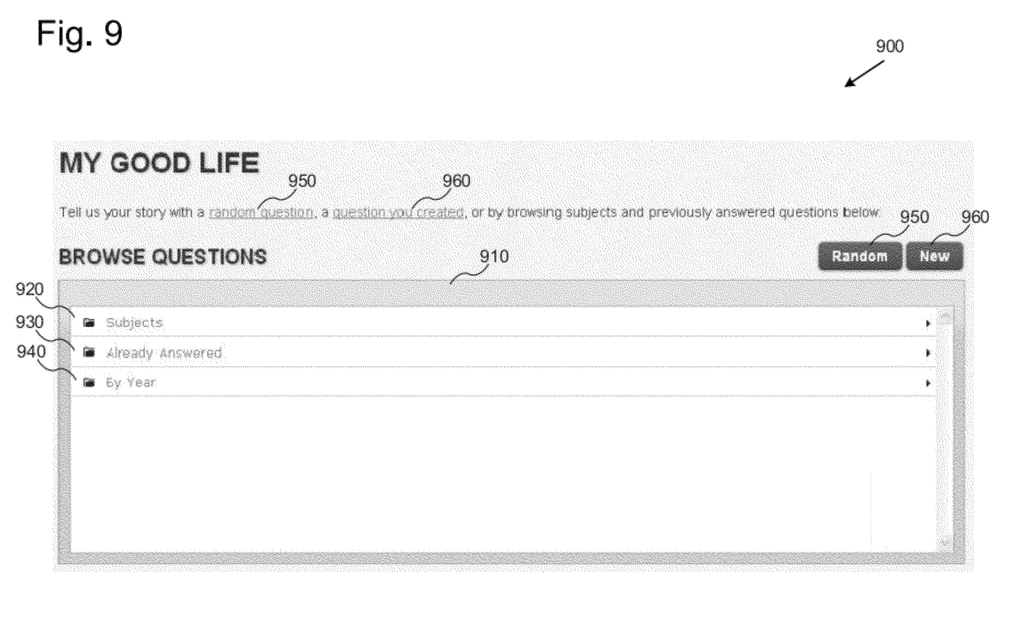

FIGS. 9-12 illustrate example interfaces 900, 1000, 1100, and 1200 for selecting a question to direct a response for inclusion in a book. While the interface examples of FIGS. 9-12 illustrate particular graphical elements and offer particular interactions to a user, it will be recognized that, in various embodiments, different interfaces may include different graphical and/or interactive configurations. In various embodiments, the interactive story compiler 100 may provide a question selection element 910, which allows an author to browse through stored questions and select a question which will direct a response.

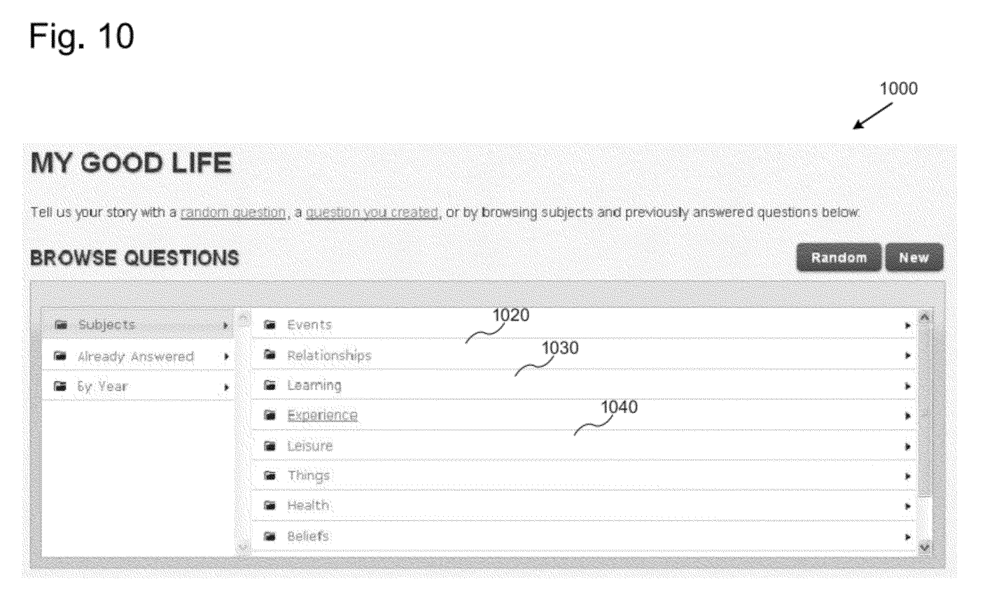

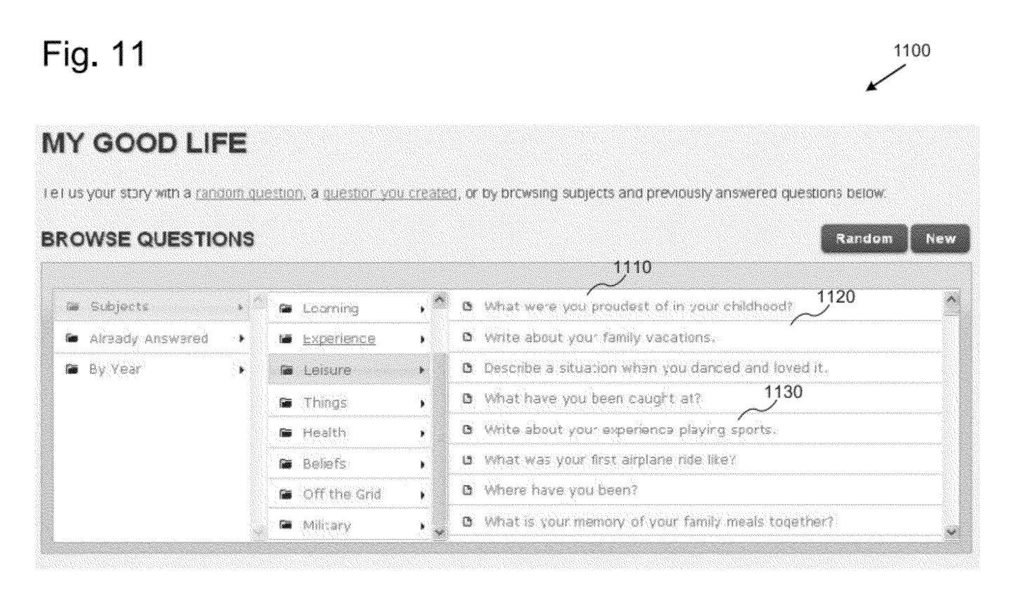

In various embodiments, the interactive story compiler 100 may provide a subject selection element 920. The subject selection element 920, when selected, may cause the interactive story compiler 100 to display one or more selectable elements with subject headings under which questions are stored. FIG. 10 shows examples of such subject headings, including Relationships element 1020, Learning element 1030, and Leisure element 1040. In various embodiments, the subject headings elements, when selected, may cause the interactive story compiler 100 to display one or more selectable question elements with stored questions which the author may answer. FIG. 11 shows examples of such stored questions, such as questions “What were you proudest of in your childhood?” (1110), “Write about your family vacations.” (1120), and “Write about your experience playing sports.” (1130). As the examples of FIG. 11 show, in various embodiments, the questions presented by the interactive story compiler 100 may not necessarily be phrased as grammatical questions; some may be phrased as directions for further response. In various embodiments, the selectable question elements, when selected, may cause the interactive story compiler 100 to provide an interface for providing a written response to the associated questions. Details of such embodiments are described below.

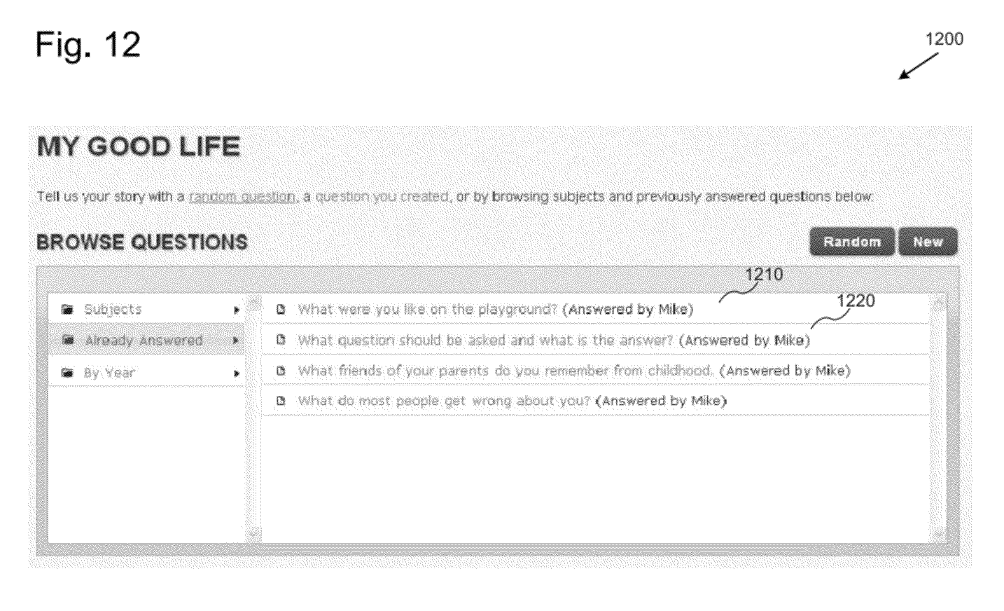

Returning to FIG. 9, the interactive story compiler 100 may also provide an already-answered selection element 930. In various embodiments, the already-answered selection element 930, when selected, may cause the interactive story compiler 100 to display one or more selectable already-answered question elements for which written responses have already been stored. FIG. 12 shows examples of such questions with stored responses, such as questions “What were you like on the playground?” (1210) and “What question should be asked and what is the answer?” (1220). As discussed above, in various embodiments, the selectable already-answered question elements, when selected, may cause the interactive story compiler 100 to provide an interface for editing the previously-stored written response to the associated questions.

In various embodiments, the interactive story compiler 100 may also provide a date-related selection element 940 of FIG. 9. In various embodiments, selection of the date-related selection element 940 may cause the interactive story compiler 100 to display dates for which written responses have been stored. Interaction with the stored answers may be performed in a manner similar to those interactions described above.

As FIG. 9 also illustrates, in various embodiments, the interactive story compiler 100 may provide one or more random question selection elements 950. In various embodiments, the random question selection elements 950, when selected, may cause the interactive story compiler 100 to provide an editing screen for providing a response to a random question out of those stored in the question storage 110. In various embodiments, the interactive story compiler 100 may also provide one or more new question selection elements 960. In various embodiments, the new question selection elements 960, when selected, may cause the interactive story compiler 100 to provide an editing screen for providing both a question and a response to the question, as described above. In various embodiments, one or more of the selectable elements of the interfaces provided by the interactive story compiler 100 may be provided as text elements and/or graphical elements, as can be seen in the examples of the random question selection elements 950 and the new question selection elements 960.

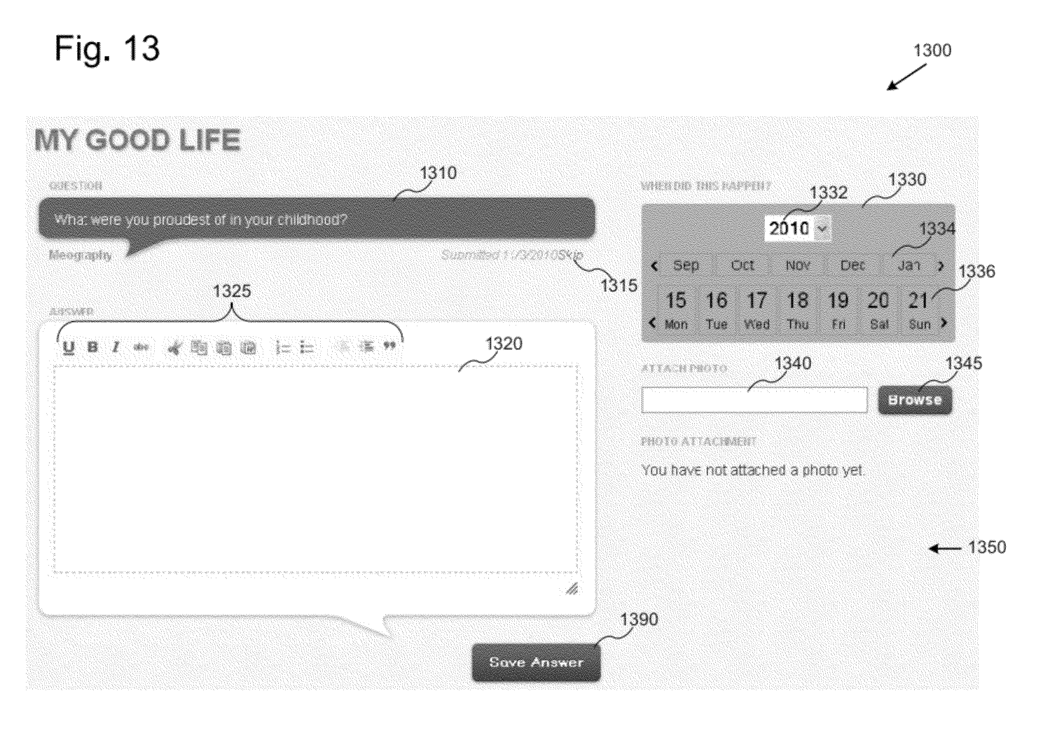

FIG. 13 illustrates one example of an interface 1300 for entering a written response to a stored question. While the interface example of FIG. 13 illustrates particular graphical elements and offers particular interactions to a user, it will be recognized that, in various embodiments, different interfaces may include different graphical and/or interactive configurations. As illustrated in FIG. 13, in various embodiments, the interactive story compiler 100 may present an element showing the selected question, such as question element 1310. In various embodiments, the question element 1310 may be presented prominently in the interface 1300 in order to focus the author's response to the call of the selected question. The interface 1300 may also contain a skip element 1315 which, when selected, may cause the interactive story compiler 100 to display an editing interface for another question, such as a randomly-chosen question. In order to allow for editing and/or creation of a written response to a selected, the interactive story compiler 100 may provide a written response editing element 1320, in which the author may enter and/or edit his or her written response. The interface 1300 may also comprise editing tools, such as editing elements 1325, which may provide for common text editing and formatting capabilities. In various embodiments, in scenarios where an author has previously written and saved a response to a question, the written response editing element 1320 may be pre-populated with the text of the stored written response.

In various embodiments, the interactive story compiler 100 may also present interface elements for selecting a time period which is to be associated with the written response. Thus, in interface 1300, the interactive story compiler 100 may present a time period selection element 1330. In various embodiments, the time period selection element 1330 may comprise one or more of a year selection element 1332, a month selection element 1334, and a date selection element 1336. In various embodiments, an author may select one or more of these time-based elements to associate time periods with written responses at different levels of granularity.

In various embodiments, the interactive story compiler 100 may also present interface elements for selecting an image which is to be associated with the written response. Thus, in interface 1300, the interactive story compiler 100 may present image browsing elements 1240 and 1245 for locating and selecting an image in a directory. Additionally in various embodiments, an image, once selected, may be displayed to the author currently editing the written response so that the author may verify that the selected image is the proper image.

In various embodiments, the interactive story compiler 100 may provide a save answer element 1390, which, when selected, causes the interactive story compiler 100 to save edits made through interface 1300. In various embodiments, saving edits may comprise both saving written responses as well as selections of associated time periods and/or images.

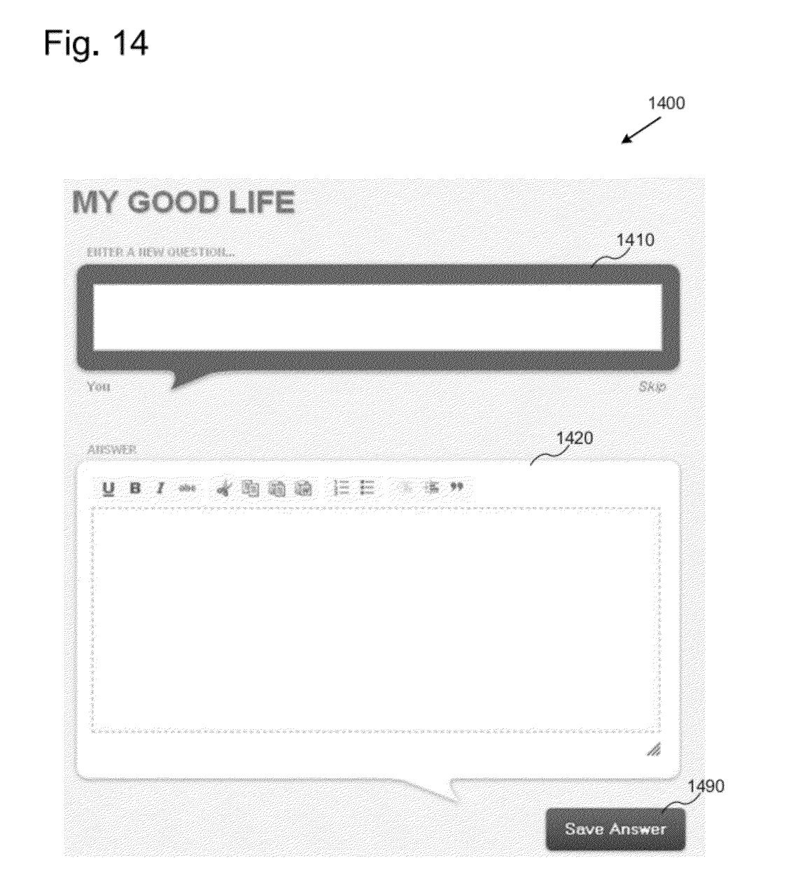

FIG. 14 illustrates one example of an interface 1400 for entering a new question and a written response to the new question. While the interface example of FIG. 14 illustrates particular graphical elements and offers particular interactions to a user, it will be recognized that, in various embodiments, different interfaces may include different graphical and/or interactive configurations. As illustrated in FIG. 14, in various embodiments, the interactive story compiler 100 may present a written response editing element 1420 which may be similar to the written response editing element 1320 of FIG. 13. However, in the example of FIG. 14, the interactive story compiler 100 may also present question editing element 1410. In various embodiments, the question editing element 1410 may allow an author to add, delete and/or modify text for a question, while using the written response editing element 1420 to add, delete and/or modify an associated written response. In various embodiments, the interactive story compiler 100 may provide a save answer element 1490, which, when selected, causes the interactive story compiler 100 to save edits to both the written response and the question as made through interface 1400.

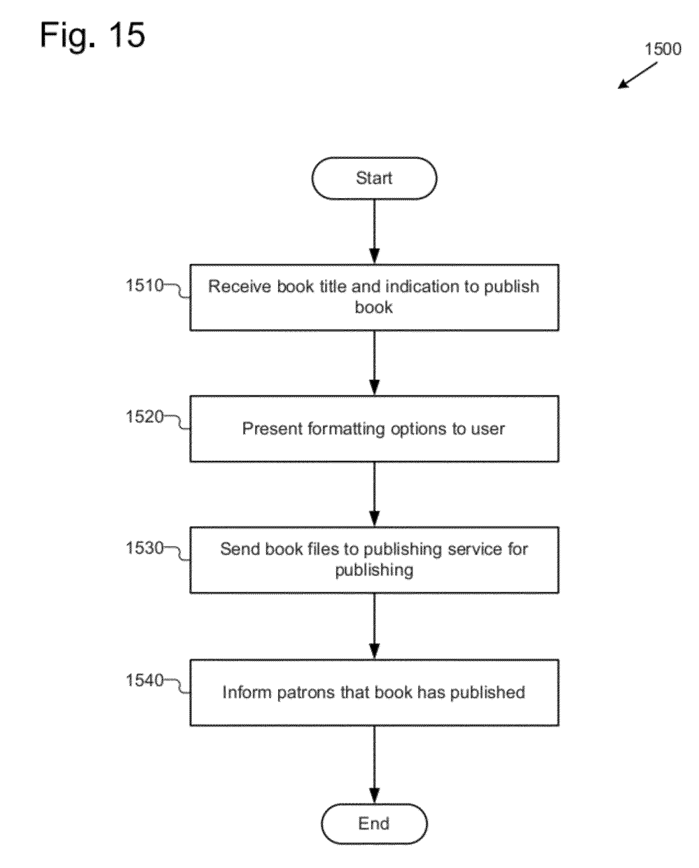

FIG. 15 is a flowchart illustrating an exemplary process 1500 for the interactive story compiler 100 to facilitate an author in publishing a book. In various embodiments, one or more of the operations illustrated in FIG. 15 may be combined, split into multiple operations, or omitted altogether. The process may begin at operation 1510, where the interactive story compiler may receive an indication of a book title along with an indication to publish the book. In one embodiment this indication may received by an author entering a book name into book name entry element 780 and subsequently selecting book publish element 790. At operation 1520, the interactive story compiler 100 may present formatting options to the author. In various embodiments, these formatting options may include font choices, binding choices, margins and other printing options. In other embodiments, the interactive story compiler 100 may also provide content-related options, such as whether to print questions alongside their written responses or to print the responses without the questions. In another embodiment, the interactive story compiler 100 may provide the author with options as to an order he or she may wish to print the written responses. While in some embodiments, authors may opt for a strict chronological ordering, in others, authors may decide to modify the order to their liking.

Next, at operation 1530, the interactive story compiler 100 may send one or more book files to a publishing service for publishing. In various embodiments, particular formats and methods of delivery of the book files may be chosen to satisfy requirements of the particular publishing service being used by the interactive story compiler 100. After publishing the book, at operation 1540, the interactive story compiler 100 may inform patrons that the book has been published. In various embodiments, the patrons who are informed may be those patrons who were identified by the author through the patron name entry element 750, patron email entry element 760, and patron invite element 770 of FIG. 7. These patrons may then be informed via email or other communication medium of the publication of the book and may be invited to purchase the published book.

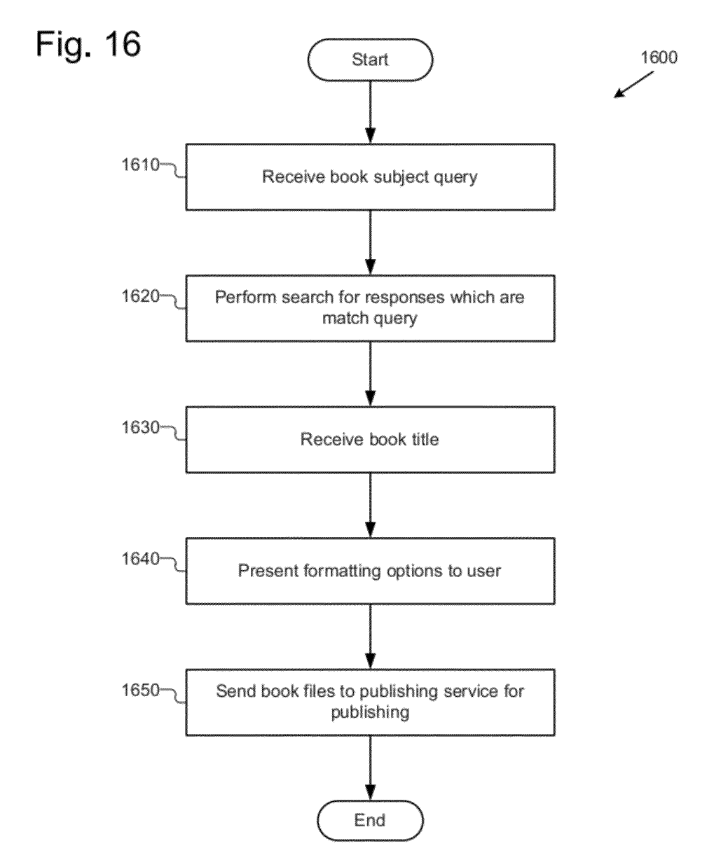

FIG. 16 is a flowchart illustrating an exemplary process 1600 for the interactive story compiler 100 to facilitate publishing a compiled book. In various embodiments, one or more of the operations illustrated in FIG. 15 may be combined, split into multiple operations, or omitted altogether. In various embodiments, the process of FIG. 1600 may be initiated by a user who has access to multiple authors' work, such as for example, a maintainer or owner of the interactive story compiler 100.

The process may begin at operation 1610, where the interactive story compiler 100 may receive a book search query for selecting related written responses. As discussed earlier, in various embodiments, the book search query may comprise keywords, time periods, tags, and/or other search query components which may relate to information stored with the written responses. At operation 1620 the interactive story compiler 100 may then perform a search through the stored written responses for responses which match or are otherwise found by the query. In alternative embodiments, the user may manually select one or more written responses, rather than using search queries to locate them. Next, at operation 1630 the interactive story compiler 100 may receive a book title form the user initiating the search.

At operation 1630, the interactive story compiler 100 may present formatting options to the user, such as in the manner discussed above. Then, at operation 1640, the interactive story compiler 100 may send one or more book files to a publishing service for publishing, such as in the manner discussed above.

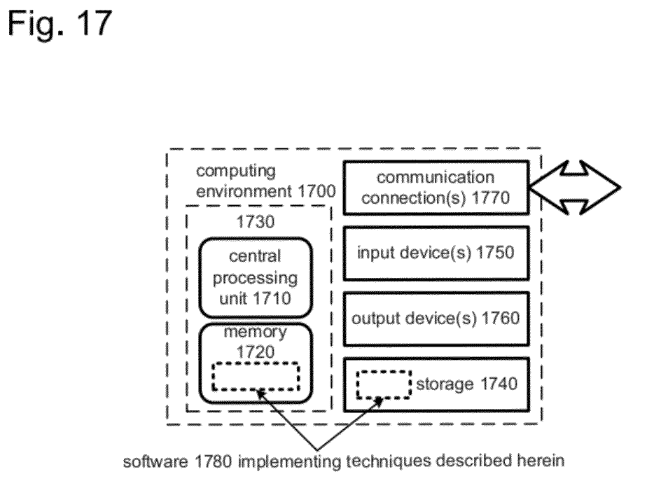

FIG. 17 illustrates a generalized example of a suitable computing environment (1700) in which several of the described embodiments may be implemented. The computing environment (1700) is not intended to suggest any limitation as to scope of use or functionality, as the techniques and tools may be implemented in diverse general-purpose or special-purpose computing environments such as personal computers, consumer electronic devices, and the like.

With reference to FIG. 17, the computing environment (1700) includes at least one CPU (1710) and associated memory (1720). In FIG. 17, this most basic configuration (1730) is included within a dashed line. The processing unit (1710) executes computer-executable instructions and may be a real or a virtual processor. In a multi-processing system, multiple processing units execute computer-executable instructions to increase processing power. The memory (1720) may be volatile memory (e.g., registers, cache, RAM), non-volatile memory (e.g., ROM, EEPROM, flash memory, etc.), or some combination of the two. The memory (1720) stores software (1780) implementing the techniques described herein.

A computing environment may have additional features. For example, the computing environment (1700) includes storage (1740), one or more input devices (1750), one or more output devices (1760), and one or more communication connections (1770). An interconnection mechanism (not shown) such as a bus, controller, or network interconnects the components of the computing environment (1700). Typically, operating system software (not shown) provides an operating environment for other software executing in the computing environment (1700), and coordinates activities of the components of the computing environment (1700).

The storage (1740) may be removable or non-removable, and includes magnetic disks, magnetic tapes or cassettes, CD-ROMs, DVDs, flash drives, disk arrays, or any other medium which can be used to store information and which can be accessed within the computing environment (1700). The storage (1740) stores instructions for the software.

The input device(s) (1750) may be a touch input device such as a keyboard, mouse, pen, or trackball, a voice input device, a scanning device, or another device that provides input to the computing environment (1700). For audio or video encoding, the input device(s) (1750) may be a sound card, video card, TV tuner card, or similar device that accepts audio or video input in analog or digital form, or a CD- or DVD-based drive that reads audio or video samples into the computing environment (1700). The output device(s) (1760) may be a display (e.g., monitor, display screen, or the like), printer, speaker, DVD-writer, or another device that provides output from the computing environment (1700).

The communication connection(s) (1770) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of non-transitory computer-readable media. Computer-readable media are any available media that can be accessed within a computing environment. By way of example, and not limitation, with the computing environment (1700), computer-readable media include memory (1720), computer-readable storage media (1740) (e.g., CDs, DVDs, diskettes, flash drives, removable hard drives, hard drive arrays), and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “complete,” “query,” and “request” to describe computer operations in a computing environment. These terms are high-level abstractions for operations performed by a computer, and should not be confused with acts performed by a human being. The actual computer operations corresponding to these terms vary depending on implementation.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A computer-implemented method for facilitating compilation of one or more authored works, the method comprising:
presenting, by a computing device, one or more questions to one or more authors;
receiving, by the computing device, one or more respective written responses to the one or more presented questions;
storing, by the computing device, the one or more respective written responses; and
facilitating, by the computing device, publishing of the one or more written responses in a published form.

2. The method of claim 1, further comprising receiving, by the computing device, an indication of a book and one or more indications of one or more authors who will collaborate on the book; and
wherein:
presenting one or more questions to one or more authors comprises presenting, by the computing device, one or more questions to the one or more identified authors; and
facilitating publishing of the one or more written responses in a published form comprises facilitating, by the computing device, publishing of the one or more written responses in the book.

3. The method of claim 1, further comprising:
receiving, by the computing device, one or more search queries relating to stored written responses; and
performing, by the computing device, a search on the stored written responses using the received one or more search queries to produce one or more related written responses; and
wherein facilitating publishing of the one or more written responses in a published form comprises facilitating, by the computing device, publishing of selected written responses out of the one or more related written responses in a published form.

4. The method of claim 3, wherein the one or more search queries comprises one or more keywords.

5. The method of claim 3, wherein the one or more search queries comprises one or more time periods.

6. The method of claim 3, wherein the one or more search queries comprises one or more tags.

7. The method of claim 1, wherein receiving one or more respective written responses to the one or more presented questions comprises, for at least one of the one or more respective written responses, receiving, by the computing device, a time period associated with the at least one of the one or more respective written responses.

8. The method of claim 7, wherein receiving a time period associated with the at least one of the one or more respective written responses comprises receiving, by the computing device, a specific date.

9. The method of claim 1, wherein facilitating publishing of the one or more written responses in a published form comprises sending, by the computing device, the one or more written responses to a publishing service over a network.

10. The method of claim 1, further comprising:
receiving, by the computing device, a request to display a selected written response out of the one or more written responses; and
in response to the request to display the written response, displaying, by the computing device, the selected written response.

11. The method of claim 10, further comprising:
receiving, by the computing device, one or more indications of private written responses out of the one or more written responses; and
in response to a request to display one of the private written responses, refusing, by the computing device, to display the selected written response.

12. The method of claim 1, further comprising:
receiving, by the computing device, an indication of a new question;
storing, by the computing device, the new question; and
wherein presenting one or more questions to one or more authors comprises presenting, by the computing device, the new question.

13. A system for facilitating compilation of one or more authored works, the system comprising:
one or more computer processors;
a question storage coupled to the one or more computer processors and configured to store one or more pre-determined questions;
a written response storage coupled to the one or more computer processors and configured to store one or more user-generated responses;
a response interaction module configured, upon execution by the one or more processors, to:
retrieve a question from the question storage;
present the question to a user;
receive a written response to the question; and
store the received written response in the response storage; and
a publishing facilitator module configured, upon execution by the one or more processors, to facilitate publishing of the one or more written responses in a published form.

14. The system of claim 13, further comprising:
a response query module configured, upon execution by the one or more processors, to:
receive a search query;
perform a search on stored written responses using the received search query, to produce one or more related written responses; and
cause the publishing facilitator module to facilitate publishing of one or more related written responses in a published form.

15. The system of claim 13, further comprising:
a privacy maintenance module configured, upon execution by the one or more processors, to:
mark one or more stored written responses as private; and
receive and store an indication of a written response that is marked private along with indications of one or more users which have permission to view the written response;
wherein the response interaction module is further configured, upon execution by the one or more processors, to refuse to display written responses which are marked private to users who are not indicated as having permission to view the written responses.

16. The system of claim 13, wherein the response interaction module is configured, upon execution by the one or more processors, to:
receive a new question from a first user; and
present the new question to a second user in place of a pre-determined question.

17. One or more computer-readable media which, responsive to execution by a computing device, cause the device to perform a computer-implemented method for facilitating compilation of one or more authored works, the method comprising:
receiving an indication of a first book;
receiving one or more indications of one or more authors who will collaborate on the book;
presenting one or more questions to the one or more authors;
receiving one or more respective written responses to the one or more presented questions;
storing the one or more respective written responses; and
facilitating publishing of the one or more written responses in the book.

18. The computer-readable media of claim 17, wherein the method further comprises:
receiving one or more search queries relating to stored written responses;
performing a search on the stored written responses using the received one or more search queries to produce one or more related written responses; and
facilitating publishing of selected written responses out of the one or more related written responses in a second book.

19. The computer-readable media of claim 17, wherein the one or more search queries comprises one or more of keywords, time periods, or tags.

20. The computer-readable media of claim 17, wherein the method further comprises:
receiving an indication of a new question; and
storing the new question; and
wherein presenting one or more questions to the one or more authors comprises presenting the new question.
